(19) United States
(12) Patent Application Publication
(10) Pub. No.: US 2003/0148779 A1
(43) Pub. Date: Aug. 7, 2003

(54) System and method of expediting call establishment in mobile communications

(75) Inventors: Murali Aravamudan, Windham, NH (US); Shamim A. Naqvi, Morristown, NJ (US); Prakash R. Iyer, North Andover, MA (US)

Correspondence Address: HALE AND DORR, LLP, 60 STATE STREET, BOSTON, MA, 02109

(73) Assignee: Winphoria Networks, Inc., Tewksbury, MA

(21) Appl. No.: 10/284,042

(22) Filed: Oct. 30, 2002

Related U.S. Application Data
(63) Continuation-in-part of application No. 09/845,934, filed on Apr. 30, 2001.
(60) Provisional application No. 60/386,883, filed on Jun. 7, 2002.

(51) Int. Cl. H04Q 7/20

(52) U.S. Cl. 455/519; 455/517

(57) ABSTRACT

Call establishment is expedited in mobile communications. While a mobile station (MS) is in a dormant state, the mobile station is prepared for a half duplex mobile communications telephone call. In response to a user's initiation of the half duplex mobile communications telephone call, the half duplex mobile communications telephone call is established based on the preparation of the mobile station.

### CROSS-REFERENCE TO RELATED APPLICATIONS

This application claims priority to and the benefit of U.S. Provisional Application Serial No. 60/386,883, filed Jun. 7, 2002, entitled “System and Method of Optimizing Latency Time in Group Calling Systems”, which is incorporated herein by reference in its entirety.

This application is a continuation in part of U.S. application Ser. No. 09/845,934, filed Apr. 30, 2001, entitled “System and Method of Group Calling in Mobile Communications”, which is incorporated herein by reference in its entirety.

### BACKGROUND OF THE INVENTION

1. Field of the Invention

This invention relates to mobile communications and, more particularly, to expediting call establishment in mobile communications.

2. Discussion of Related Art

As described in copending U.S. application Ser. No. 09/845,934, all modern mobile communication systems have a hierarchical arrangement, in which a geographical “coverage area” is partitioned into a number of smaller geographical areas called “cells.” Referring to FIG. 1, each cell is preferably served by a Base Transceiver Station (“BTS”) 102a. Several BTS 102b-n are aggregated via fixed links 104a-n into a Base Station Controller (“BSC”) 106a. The BTSs and BSC are sometimes collectively referred to as the Base Station Subsystem (“BS”) 107. Several BSCs 106b-n may be aggregated into a Mobile Switching Center (“MSC”) 110 via fixed links 108a-n.

MSC 110 acts as a local switching exchange (with additional features to handle mobility management requirements) and communicates with the phone network (“PSTN”) 120 through trunk groups. Under U.S. mobile networks, there is a concept of a home MSC and a Serving MSC. The home MSC is the MSC corresponding to the exchange associated with a Mobile Station (“MS”, also referred to as “mobile handset”, “mobile telephone handset”, or “handset”); this association is based on the phone number, e.g., area code, of the MS. (The home MSC is responsible for the HLR discussed below.) The Serving MSC, on the other hand, is the exchange used to connect the MS call to the PSTN (as the subscriber roams in the area covered by the service provider, different MSCs perform the function of the Serving MSC). Consequently, sometimes the home MSC and the Serving MSC are the same entity, but other times they are not (e.g., when the MS is roaming). Typically, a Visiting Location Register (“VLR”) 116 is co-located with the MSC 110 and a logically singular HLR is used in the mobile network. The HLR and VLR are used for storing many types of subscriber information and profiles.

Briefly, one or more radio channels 112 are associated with the entire coverage area. The radio channels are partitioned into groups of channels allocated to individual cells. The channels are used to carry signaling information to establish call connections and the like, and to carry voice or data information once a call connection is established.

At a relatively high level of abstraction, mobile network signaling involves at least two main aspects. One aspect involves the signaling between an MS and the rest of the network. With 2G (“2G” is the industry term used for “second generation”) and later technology, this signaling concerns access methods used by the MS (e.g., time-division multiple access, or TDMA; code-division multiple access, or CDMA), assignment of radio channels, authentication, etc. A second aspect involves the signaling among the various entities in the mobile network, such as the signaling among MSCs, VLRs, HLRs, etc. This second part is sometimes referred to as the Mobile Application Part (“MAP”) especially when used in the context of Signaling System No. 7 (“SS7”).

The various forms of signaling (as well as the data and voice communication) are transmitted and received in accordance with various standards. For example, the Electronics Industries Association (“EIA”) and Telecommunications Industry Association (“TIA”) help define many U.S. standards, such as IS-41, which is a MAP standard. Analogously, the CCITT and ITU help define international standards, such as GSM-MAP, which is an international MAP standard. Information about these standards is well known and may be found from the relevant organizing bodies as well as in the literature, see, e.g., Bosse, Signaling in Telecommunications Networks (Wiley 1998).

To deliver a call from an MS 114, a user dials the number and presses “send” on a cell phone or other MS. The MS 114 sends the dialed number indicating the service requested to the MSC 110 via the BS 107. The MSC 110 checks with an associated VLR 116 (more below) to determine if the MS 114 is allowed the requested service. The Serving MSC routes the call to the local exchange of the dialed user on the PSTN 120. The local exchange alerts the called user terminal, and an answer back signal is routed back to the MS 114 through the serving MSC 110 which then completes the speech path to the MS. Once the setup is completed the call may proceed.

To deliver a call to a MS 114, (assuming that the call originates from the PSTN 120) the PSTN user dials the MS's associated phone number. At least according to U.S. standards, the PSTN 120 routes the call to the MS's home MSC (which may or may not be the one serving the MS). The MSC then interrogates the HLR 118 to determine which MSC is currently serving the MS. This also acts to inform the serving MSC that a call is forthcoming. The home MSC then routes the call to the Serving MSC. The serving MSC pages the MS via the appropriate BS. The MS responds and the appropriate signaling links are setup.

During a call, the BS 107 and MS 114 may cooperate to change channels or BTSs 102, if needed, for example, because of signal conditions.

Mobile communication networks are adding newer services, e.g., “data calls” to the Internet. With respect to the Internet, multicast communication refers to the transmission of identical data packets to selected, multiple destinations on an Internet Protocol network. (In contrast, broadcast communication refers to the indiscriminate transmission of data packets to all destinations, and unicast communication refers to the transmission of data packets to a single destination.)

Each participant in a multicast receives information transmitted by any other participant in the multicast. Users connected to the network who are not participants in a particular multicast do not receive the information transmitted by the participants of the multicast. In this way, the multicast communication uses only the network components (e.g., switches and trunks) actually needed for the multicast transmission.

In multicast processing, when a potential participant (“host”) is directed to join a particular IP multicast group, the host sends a “request to join” message to the nearest multicast-capable router to request to join the multicast group and receive information sent to this group. For example, a host A sends a message to join multicast group Y, and a host B sends a message to join multicast group X. A router R propagates the request up to the multicast source if the data path is not already in place.

Upon receiving an IP packet for group X, for example, the router R maps an IP multicast group address into an Ethernet multicast address, and sends the resultant Ethernet packet to the appropriate switch or switches.

According to the current Internet Group Management Protocol (“IGMP”) a host's membership in a multicast group expires when the router does not receive a periodic membership report from the host.

With respect to interaction among MSs, a Nextel service (known as Nextel Direct Connect®, using Specialized Mobile Radio technology, and described at http://www.nextel.com/phone_services/directconnect.shtml) having two versions has been proposed for special connection calls among MSs. Both versions of the special connection calls require that all members be located in the same switching area controlled by a BSC/DAP (Dispatch Application Processor) combination. In the first version, a one to one conversation is allowed between two mobile telephone subscribers, e.g., A and B. When A wishes to have special connection communication with B, A enters B's private identification number, holds down a push to talk (“PTT”) button, waits for an audible alert signifying that B is ready to receive, and starts speaking. To listen, A releases the PTT button. If B wishes to speak, B holds down the PTT button and waits for an audible confirmation that A is ready to receive. The service allows a subscriber to choose private identification numbers from scrollable lists displayed on mobile telephone handsets or to search a list of pre-stored names of subscribers.

In the second version, conversations are allowed among members of a pre-defined group of subscribers, known as a Talkgroup, which is identified by a number. The mobile telephone handset allows Talkgroup numbers to be searched through the control surface of the handset. In order to place a group call, the initiating subscriber, e.g., A, locates a Talkgroup number in the handset, holds down the PTT button, and, upon receiving an audible confirmation such as a chirp, can start speaking. All of the other Talkgroup members on the group call can only listen while A is holding down the PTT button. If A releases the PTT button, another member on the group call may hold down the PTT button, acquire control signaled by the audible confirmation, and start speaking.

Among the earliest examples of a group calling system is a Two Way Talk Radio (TWTR) system, i.e., an analog half duplex radio system which precedes Nextel Direct Connect® and in which, during a transmission, the transmitting (broadcasting) transceiver has its transmitter turned on and its receiver turned off while the receiving transceivers have their transmitters turned off and their receivers turned on. The latency in TWTR systems is virtually zero, being governed by the velocity of radio waves and the propagation times of electronic components. Another feature of such systems is that the broadcasting caller has no a priori knowledge of the presence of listeners. It is only when at least one of the listeners responds that the caller can ascertain the presence of any listeners. Accordingly, the typical mode of group calling includes a “human protocol” in which the caller first ascertains the presence of one or more listeners, e.g., using phrases such as “Are you there?”, when establishing a group call. If no meaningful communication can take place in a group call before the presence of listeners has been confirmed, a latency period referred to as the Human Round Trip Response Time (HRTRT) dictates TWTR's perceived latency. In at least some cases, when the handset is easily accessible to the called party, the HRTRT ranges from 1.5 to 4 seconds, in contrast to the delay due to the velocity of radio waves which may be 0.03 milliseconds over a 5-mile distance.

In some PTT systems, digital radios are used for coded and framed half duplex voice communication. Unlike the TWTR systems, the digital radio based PTT systems use explicit signaling to establish the group calls. Due to the explicit signaling and group call set up activity, the coding and digital framing of the originally analog voice signal, and transmission delays, such systems have significant latency, which in at least some cases may range from 750 milliseconds to 1.5 seconds. Also, digital radio based PTT systems are unlike TWTR systems in that the caller is aware of the presence of the listeners. Typically, a digital radio based PTT system plays a sound referred to as a “chirp” to indicate the presence of one or more listeners after which the caller may proceed with the call. Thus, the HRTRT latency remains relevant in digital radio based PTT systems because the caller needs to know if the listener is available and attentive. The chirp only indicates that the handset is available; it gives no indication of the state of the listener. The caller does not know whether the listener is busy with something else or whether the handset is at some distance from the listener, e.g., on a kitchen counter several feet away from the listener. In at least some cases, the HRTRT in current digital radio based PTT systems may range from 2 to 5 seconds when the handset is easily accessible to the listener.

In some implementations of digital radio based PTT systems that use standard air interfaces (RF modulation) such as the CDMA 1×RTT interface, the HRTRT may be as large as 12-15 seconds. These interfaces are not optimized for PTT-style group calls and introduce various latencies if used to deliver PTT calls. A typical PTT call in 1×RTT networks can have an HRTRT latency of 15 seconds, which can create a serious impediment to a successful deployment of new PTT systems.

Overall latency includes at least the following factors. As described above, presence latency is the latency due to the time consumed as the caller determines that the called party is present and hence can begin talking. Presence latency occurs once, when the caller initiates the group call. Call setup latency is the latency due to the time consumed as the called party determines the intent of the caller. Call setup latency occurs once, at the outset of the group call. Media latency is the latency due to the time consumed before a talk spurt uttered by one party in the group call is heard by the other parties in the call, and includes buffering time, coding time, and transmission delays of the voice media. As described above, HRTRT is the latency due to the time consumed before the caller hears the called party, i.e., after the caller speaks and releases control, and the called party listens acquires control and speaks.

Conventional 1×RTT PTT service uses Packet Switched Data (PSD) as the transport mechanism with RTP/UDP/IP with voice being coded as EVRC (Enhanced Variable Rate Codec), and SIP (Session Initiation Protocol) as the explicit signaling protocol. In 1×RTT networks the handset enters a dormant state if there is no packet data activity for a period of time known as the dormancy interval, which is a network configurable parameter. When data activity for a dormant handset starts, the handset executes a transition from the dormant state to an active state. Thus, if a participant in a group call has a handset that is dormant, the time that is consumed as the handset goes from the dormant state to the active state also contributes to the overall latency in the group call. In at least some cases, average call setup latencies (including presence latency) may range from 1.5 to 3 seconds for participants having active handsets, and may range from 5 to 10 seconds for participants having dormant handsets. In at least some cases, average media latencies may range from 400 milliseconds to 600 milliseconds, and HRTRT may range from 5 to 7 seconds for participants with active handsets and may range from 7 to 14 seconds for participants with dormant handsets.

Another aspect of the typical implementation of 1×RTT networks is the “R-P context” implementation feature, according to which the PPP session associated with a handset is terminated by the network, i.e., the R-P node, if there has been a lack of activity for a period of time. A lack of R-P context also contributes to the latency of group calls in typical 1×RTT networks.

In the case of a lack of activity for a period of time, according to a dormancy characteristic of a 1×RTT network, the PPP session is maintained but the air resources are released for other use. When data is available to be transmitted, restoring the air resources (i.e., “waking up the handset”) consumes time, which contributes to latency.

### SUMMARY

The invention generally provides systems and methods of mobile communication and specifically provides a system and method for expediting call establishment in mobile communications, particularly in push to talk calls and group calling. While a mobile station (MS) is in a dormant state, the mobile station is prepared for a half duplex mobile communications telephone call. In response to a user's initiation of the half duplex mobile communications telephone call, the half duplex mobile communications telephone call is established based on the preparation of the mobile station.

By expediting call establishment, the mobile communications system can provide the user with a nearly latency free PTT system or group call system. The provider can efficiently allocate network resources in accordance with economic incentives to reduce latency effectively. Users can communicate quickly, accurately, and cost-effectively with advance knowledge of other users' availability.

### BRIEF DESCRIPTION OF THE DRAWING

In the Drawing,

FIG. 1 is a system diagram of prior art mobile networks;

FIG. 2 illustrates a block diagram of a system including group call or push to talk logic;

FIGS. 3-4 illustrate a proxy switch and certain deployments in a mobile network;

FIGS. 5-6, 8 illustrate architectures of a group or push to talk communication system;

FIGS. 7, 9-20 are call flow diagrams of uses of a group or push to talk communication system; and

FIGS. 21-28 are charts showing results of tests of latency reduction techniques.

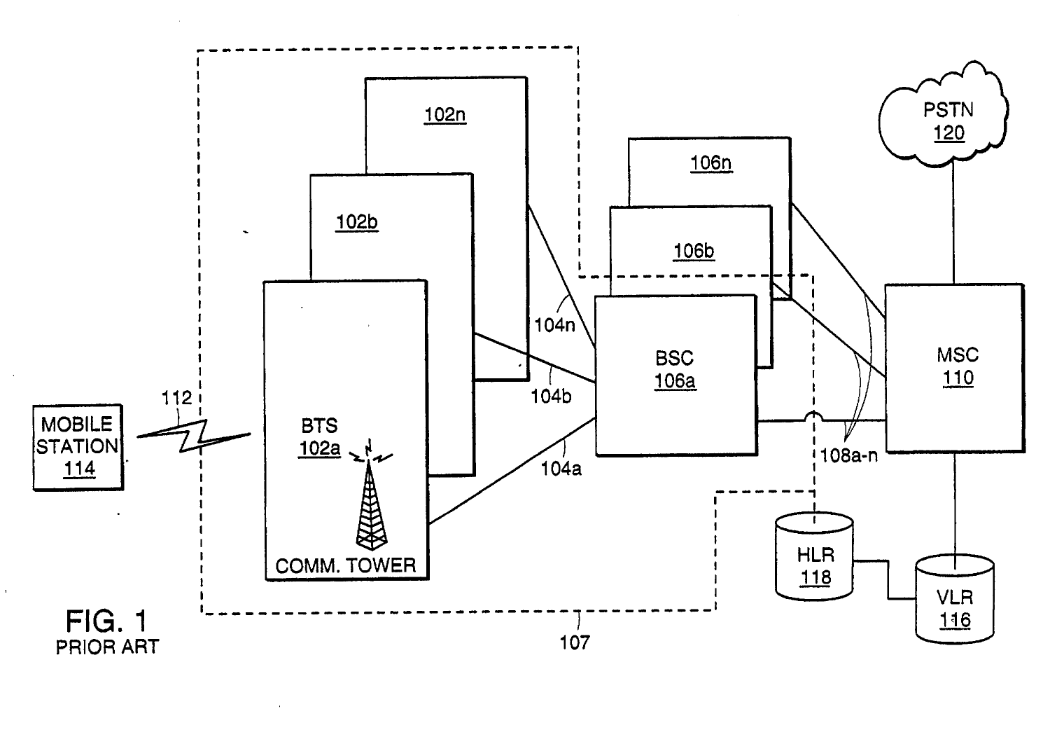

### DETAILED DESCRIPTION

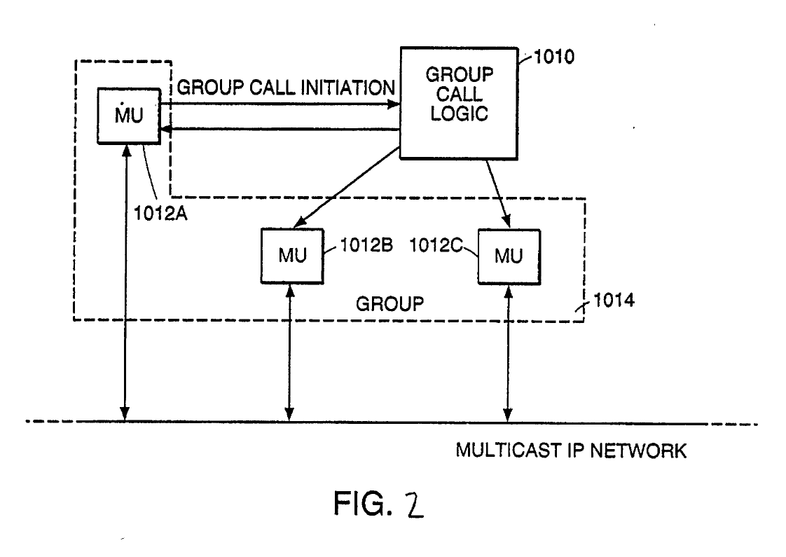

Copending U.S. application Ser. No. 09/845,934 describes a system and method for arranging calls among members of a predefined group of mobile telephone users. With respect to FIG. 2, as described in copending U.S. application Ser. No. 09/845,934, a proxy switch or other device implementing group call logic 1010 detects a group call initiation by a member 1012A of a group 1014 and automatically attempts to connect all of the members 1012A, 1012B, 1012C of the group in a group call. In a specific implementation, communication in the group call is half duplex (i.e., only one member may speak at a time), and the voice traffic for the group is carried over an Internet Protocol (“IP”) network in a multicast session.

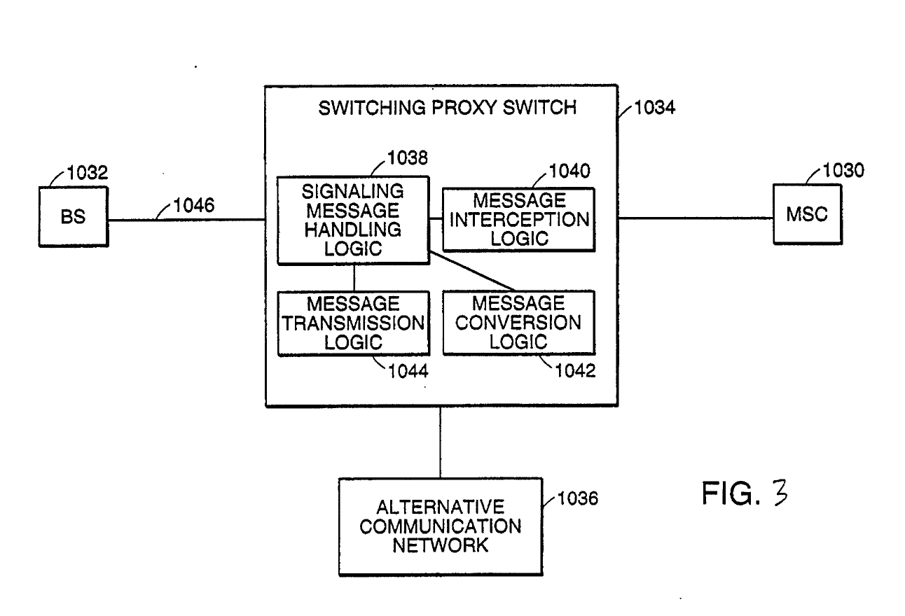

With respect to the case in which the group call logic is implemented by a proxy switch, the proxy switch may operate as described in copending U.S. application Ser. No. 09/721,329, filed Nov. 22, 2000, entitled “System and Method of Servicing Mobile Communications with a Proxy Switch”, which is incorporated herein by reference. As described in copending U.S. application Ser. No. 09/721,329 and illustrated in FIG. 3, switching 1034 operations are performed between at least one mobile switching center (“MSC”) 1030 and at least one base station subsystem (“BS”) 1032. The switching allows communication traffic to be siphoned to or from an alternative network 1036 such as an IP network. The switching is transparent so that neither the MSC nor the BS needs any changes to work with the inventive switching.

The proxy switch described in copending U.S. application Ser. No. 09/721,329 includes signaling message handling logic 1038 to receive signaling messages from the MSC and BS in accordance with a mobile signaling protocol. Message interception logic 1040 cooperates with the signaling message handling logic and sends an acknowledgment message to an MSC or BS that transmitted a signaling message. The message interception logic also prevents the signaling messages from being forwarded to the other of the BS and MSC respectively. Message conversion logic 1042 cooperates with the signaling message handling logic and converts a signaling message from one of the MSC and BS into a converted signaling message for transmission to the other of the BS and MSC, respectively. Message transmission logic 1044 cooperates with the signaling message handling logic and transmits signaling messages from one of the MSC and the BS to the other of the BS and MSC, respectively.

A set of bearer circuits 1046 from the BS are allocated to the proxy switch. Signaling messages between the MSC and the BS are received and are analyzed to determine whether they correspond to the allocated set of bearer circuits. If so, control information in the signaling messages is conveyed to the alternative communication network; and information carried on the set of bearer circuits is siphoned to the alternative network.

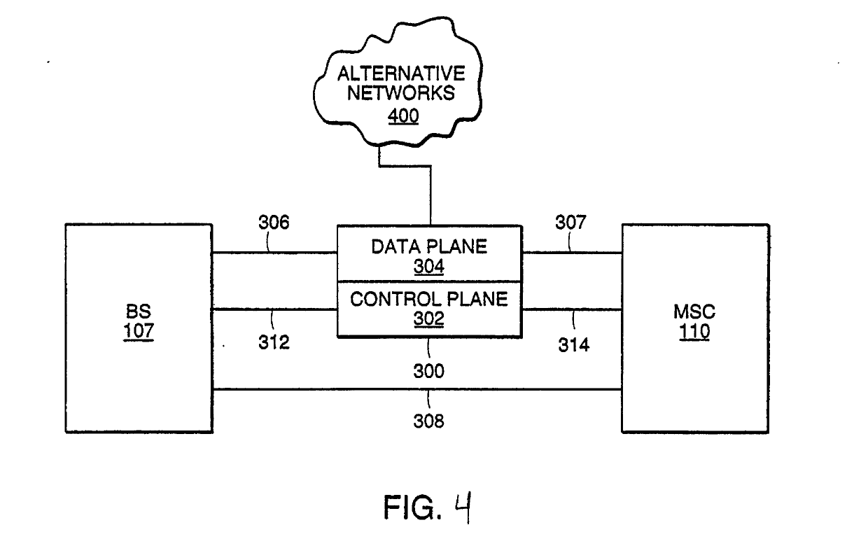

FIG. 4 shows one preferred deployment of a proxy switch 300, in which the proxy switch 300 is positioned between the BS 107 and the MSC 110. Only a subset of trunks 306 carrying user traffic needs to be terminated on the proxy switch; other trunks 308 may directly connect the MSC 110 and BS 107. All control links 312 from BS 107 terminate at proxy switch 300. The proxy switch includes a control plane 302 and a data plane 304 (also known as a “bearer plane”). The control plane 302 handles all the signaling traffic, and the data plane 304 handles all the user traffic for the trunks connected to the proxy switch.

Under certain embodiments, there is a one to one correspondence between an MSC and a proxy switch. Several BSs may work with a single proxy switch.

The proxy switch 300 includes software that accepts all signaling messages and, depending on the message and the state of the system, performs at least one of the following:

1. passes the message unaltered to the MSC or BS addressed in the message;

2. intercepts messages between the MSC and BS;

3. for some intercepted messages, converts the intercepted messages to a different message and sends the converted message in place of the original, intercepted message to the MSC or BS addressed in the intercepted message;

4. siphons the message from the mobile- and PSTN-based network to an alternative network such as an IP network.

The types of actions performed in each case along with the triggering events are described below.

In many instances, particularly when a message from an MS 114 is siphoned and the traffic is directed to an alternative network, the proxy switch 300 may act as an MSC 110. In such a role, the proxy switch fulfills the responsibilities and roles that a traditional MSC would perform. Some of these functions and roles pertain to mobility management. Consider the case of a roaming MS; as it roams from one cell to another, it may roam to a cell served by a different MSC, thus necessitating a handoff between the source and target MSCs. If the proxy switch 300 has siphoned the message and the call/session has been directed to an alternative network, then the handoff is managed by the proxy switch analogously to the way a handoff would be managed by a conventional MSC. The proxy switch causes the appropriate databases to be updated with the new location of the MS.

Another function of the proxy switch pertains to the assignment of resources. In particular, when an MS initiates a message requesting a new call/session, appropriate circuits (channels) need to be assigned for this session. Depending on the configuration of the system and the system state, the proxy switch makes such assignments analogously to the way conventional MSC assigns circuits.

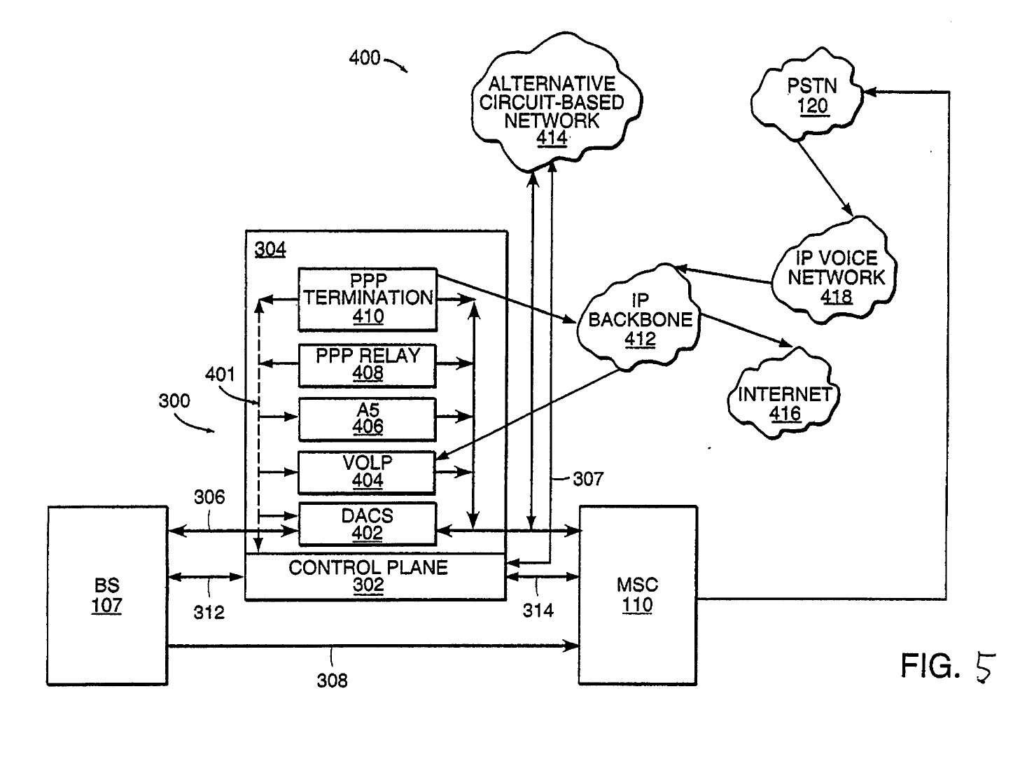

FIG. 5 shows an exemplary deployment in which the proxy switch 300 is connected to several alternative networks, such as an IP backbone 412 or an alternative circuit-based network 414, e.g., a different carrier. These alternative networks may be used to carry voice and/or data traffic to desired destinations while avoiding in whole or in part the PSTN 120 along with the costly resources of MSC 110. Alternatively, these arrangements may be used so that circuit traffic could be backhauled to a different network; for example, circuit traffic from Nashua, N.H. could be backhauled to an MSC in Waltham Mass. Or, they may be used to connect to other networks. For example, the IP backbone 412 may communicate with IP voice networks 418 or the Internet 416. As explained in the copending application, when siphoning traffic to an alternative network both control information (e.g., from the signaling messages) and voice or data from the bearer circuits on links 306 may be sent via an alternative network.

In a specific implementation of the group communication system described in copending U.S. application Ser. No. 09/845,934, mobile communications users (“users”) belonging to a closed user group (“group” or “CUG”) are provided with an ability to contact each other quickly and easily and thereby start conversing with each other. Each group includes two or more users (“members”), and a user may belong to multiple CUGs. Conversations may occur between two members of a group (“private mode”) or between all available members of a CUG (“public mode”). The group communication system uses conventional mobile communications equipment such as cellular telephones and mobile PDAs.

In a specific implementation, the group communication system implements group call logic in proxy switches logically disposed between MSCs and BSCs as described above to intercept group call initiations, bypass the MSCs and the PSTN, and implement the group calls as IP multicast sessions performing Voice over IP (“VoIP”). The users in a group may be served in disparate geographical locations by multiple MSCs spanning an aggregate network that relies one or more on wireless technologies such as CDMA, TDMA (including IS-136 and GSM), GPRS, and third generation technologies. For example, among the group members joined on any one group call, one or more users may be roaming in a GSM network simultaneously with one or more users roaming in a CDMA network. Control information pertaining to a group call can be made available for one or more users such as display participants in the group call while the group call is in progress. Group call lists may be dynamically created and modified by the group call user, using standard numbering schemes such as MIN, IMSI, and ESN.

The general architecture for an example embodiment of the group communication system is shown by example in FIG. 6. FIG. 6 shows four users in a group call using wireless devices 1060A-1060D connected to different BTS systems 1062A-1062D. For the purposes of the following description, it is assumed that the wireless devices have both audio and textual display capabilities. The BTSs are connected to Base Station Controllers (“BSCs”) 1064A-1064D, which are connected to proxy switches implementing group call logic (“group call switches”) 1066A-1066C. Each group call switch is connected to an MSC such as MSC 1068A, 1068B, or 1068C. At least one group call switch is provided for every MSC in a group call service enabled network. With respect to signaling information, each group call switch is logically located between a corresponding BSC and a corresponding MSC. The group call switch receives signaling and data from the MSC and in the reverse direction from the wireless devices via the BTS and the BSC. Each group call switch operates such that neither the BSC nor the MSC is made aware of the group call switch that lies between the BSC and the MSC. The signaling and control information from the MSC and the BSC is intercepted by the group call switch and is seamlessly passed on to the concerned elements as necessary without any discernible change.

The MSCs connect to the Public Land Mobile Network (“PLMN”) 1070 and the group call switches connect to a backbone multicast enabled IP network (“backbone network”) 1072, which provides access to a CUG Active Directory 1074 and an Enhanced Home Location Register (“HLR”′) 1076.

As described above with respect to the proxy switch of the copending application, the group call switch includes a control plane and a data plane. The functions at the control plane are the termination of the signaling messages from the BSC or the MSC or both. For example, in CDMA networks the signaling messages are defined by the IS-634 protocol specification. The control plane terminates the incoming signals and generates new signaling messages for onward transmission to the MSC or other elements. The control plane also supports a multicast function described below.

In one particular embodiment, the data plane of the group call switch receives TDM traffic from the BSC or the MSC or both and uses a TDM cross connect (“DACS”) (FIG. 4) to interface the incoming traffic to an outgoing destination. In other embodiments, the data plane may also receive incoming IP traffic from the Base Station complex (also known as the Radio Access Network, or “RAN”), and switch the incoming IP traffic to outgoing IP traffic. Programmatic control in the control plane determines cross connections between incoming TDM traffic and outgoing destinations, particularly the traditional MSC and/or destinations on an IP network.

In the case of the MSC serving as the outgoing destination from the DACS, the group call switch is essentially transparent to the network; traffic and control flows seamlessly from the BSC to the MSC and from the MSC to the BSC. When the outgoing destination is instead on an IP network, a Media Gateway (described in the copending application) in the data plane diverts selected parts of the incoming TDM traffic away from the MSC and converts incoming TDM traffic to RTP/UD/IP traffic and inserts the RTP/UD/IP traffic into the backbone IP network.

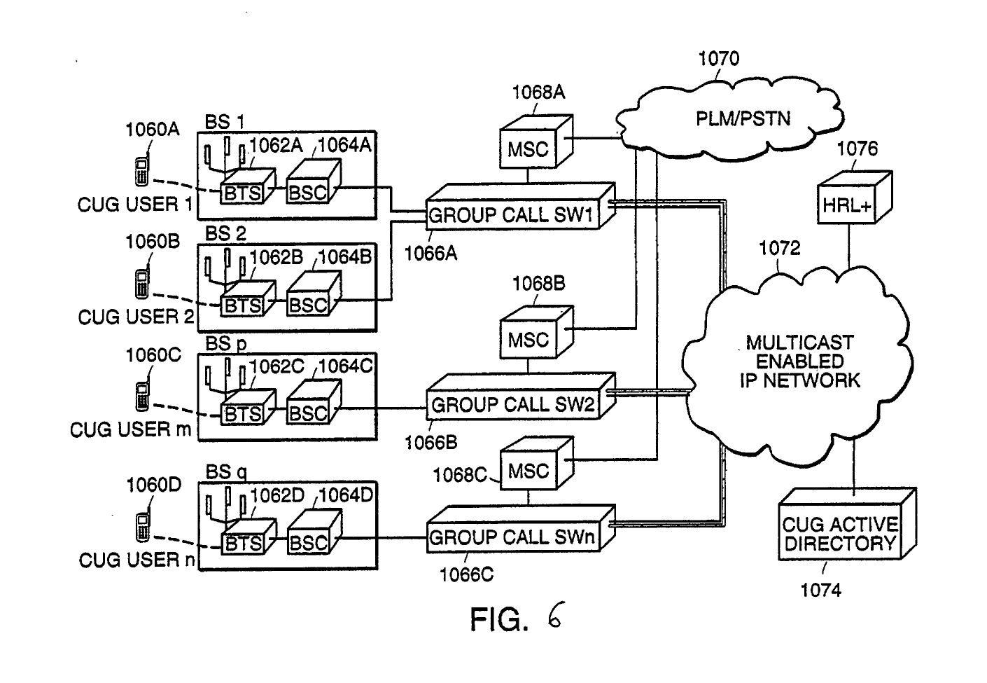

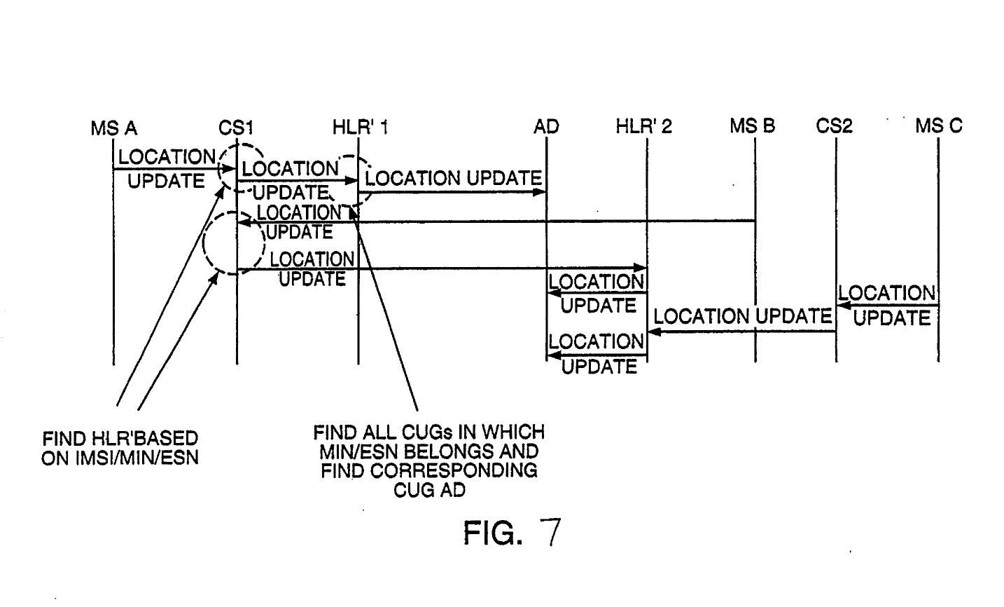

The CUG Active Directory (“CUG AD”) 1074, also known as the Group Call Registry (“GCR”), is a database system containing the CUG data. In a specific implementation, CUG AD in FIG. 7 is implemented as a distributed database system for scalability. The CUG AD contains the definitions of all the CUGs in the group call network. An inquiry to the CUG AD specifies the identifier of a CUG, i.e., the inquiry asks for the definition of a specified CUG, and the result is a list of group user IDs for all the members of the specified CUG. For example, an inquiry specifying CUG ID 2347 may cause the CUG AD to produce a result that identifies Mobile Identification Numbers (“MINs”) xxx, yyy, zzz, and www for the four users in the CUG. In a specific implementation, MIN numbers are assigned to the users of the GIR service by the service provider.

Each CUG is identified to the system by a unique identifier ID derived from a CUG namespace which is partitioned such that different partitions are assigned to different, distributed parts of the CUG AD. A partitioning index of the partitioning scheme is made available to all the group call switches. When a group call switch needs to retrieve the definition of a CUG, the group call switch can use the index to determine the component of the CUG AD to be queried.

In a specific implementation described in copending U.S. application Ser. No. 09/845,934, the group call service operates in the IP network using-IP multicast. IP multicast allows a source to send a single copy of a stream of VoIP packets which is received by multiple recipients who have explicitly registered to receive the stream. Multicast is a receiver-based concept such that receivers join a particular multicast session group and the stream is delivered to all members of that group by the network infrastructure. Only one copy of a multicast stream is passed over any link in the IP network, and copies are made only at IP multicast enabled media gateways as necessary.

Call establishment including connections and communications may be expedited by using latency reduction techniques as described below. In particular, the techniques improve the latency characteristics of group calls (including PTT calls) in 1×RTT networks, and allow a carrier to offer different classes of PTT service distinguished by varying degrees of latency. For example, the following three classes of services may be offered:

Gold: the user's handset does not enter a dormant state, i.e., is an “always on” device;

Silver: the user's handset may enter a dormant state but user's PPP session is never terminated, i.e., is “always on” PPP; and

Bronze: regular service without latency reduction.

In a specific implementation, the system may be implemented by including appropriate methods and systems in handsets and appropriate methods and systems in the proxy switch. The methods and systems implemented in handsets may include user interface enhancements and signal interpretation methods and systems. FIG. 8 illustrates components of an example implementation 2010 in which first and second mobile handsets 2012, 2014 communicate, via a first radio access network (RAN) 2016 and a first packet data serving node (PDSN) 2018 through the Internet 2020 and a second PDSN 2022 and a second RAN 2024, with third and fourth mobile handsets 2026, 2028. Each RAN has at least one base station (BS) such as BS 2030 and at least one Base Station Controller (BSC) 2032. At least one proxy switch 2034 communicates with PDSNs 2018, 2022 via the Internet using SIP explicit signaling. BSC 2032 communicates via the proxy switch 2034 with a legacy Mobile Switching Center (MSC) such as MSC 2035, which connects to the PSTN. RANs 2016, 2024 communicate with corresponding PDSNs 2018, 2022 using bearer signals (R-P).

As described in copending U.S. application Ser. Nos. 09/721,329 and 09/845,934, the proxy switch monitors traffic passing between the MSC and the BSC and may intercept traffic and/or take action depending on the content or condition of the traffic.

Each PDSN serves as a router to route packets to and from the corresponding RAN, and maintains R-P contexts so that a session is maintained as a handset roams. Each PDSN may also perform authentication of a data subscriber.

The MSC receives explicit signaling from a mobile handset and uses logic perform tasks such as processing group call setup requests and administering talk control. The MSC also performs mobility management for the handset.

A sample system may use one or more of the following latency reduction techniques.

A periodic presence information push (PPIP) technique makes use of the Group Call Register (GCR) which is a database that is described above and in copending U.S. application Ser. No. 09/845,934. The GCR contains information on subscribers and their group calling lists. In the PPIP technique, the GCR is also used to maintain presence information about the subscribers, which presence information is “pushed” to the subscribers' handsets. Thus, due to the “presence push”, a caller is constantly or almost constantly aware of the presence of at least some of the caller's group list members (e.g., 32 users per group). Accordingly, the presence latency is effectively eliminated and the caller can converse meaningfully as soon as the caller presses the PTT button.

An MS becomes “present” when the MS is turned on and completes its registration procedure. The MS remains present as long as periodic location updates to the HLR and responses to paging requests are executed timely. Otherwise, such as when the MS is turned off or strays beyond signal coverage, the MS is de-registered and is considered “not present”.

The rate of the presence push can be configured to produce a manageable level of network overhead, and the refresh rate of the presence push can be tied to a subscriber's class of service. For example, the network may refresh every few seconds for Gold class subscribers, and less often or not at all for other subscribers.

In a particular example, a caller may wish to place a group call to members of a soccer club. In a system lacking the PPIP technique, the caller does not know whether the intended recipients are present or not. In an example implementation of the PPIP technique, an indication of whether group members are present is constantly displayed in a bar at the top of the handset's screen. As a result, if at least one group member is present, the caller can press a button and immediately ask “are we on for soccer?”

The PPIP technique can add significant traffic on the network which may support 5 million or 10 million users, in the form of update information concerning the presence of the group members. Thus, different classes of service as described above may correspond to different update rates and different burdens on the network.

In another latency reduction technique referenced herein as an “early streaming” technique, the registration phase of the PTT service, which occurs when a handset is first powered on, is also used to initiate media gateway port negotiation (the negotiation is described in copending U.S. application Ser. No. 09/845,934). Thus, the ports that the subscriber and the subscriber's group would be using for the group call are negotiated in advance as a part of the registration process, saving the time used in this process that contributes to call setup latency. Another aspect of the early streaming technique is that since the ports are identified in advance, any packets (signifying non-silence) can be detected in-band on the ports. If traffic is thereby detected from any of the members of the group call, the speaking control (“talk control”) process can be initiated as described in copending U.S. application Ser. No. 09/845,934 to give the caller control of the call, which reduces the latency by reducing or eliminating talk control setup time in a PTT or group call.

In a latency situation, a registration procedure is executed when a handset is turned on, and voice packets are not sent until a signaling connection has been made based on the registration procedure. In the early streaming latency reduction technique, voice packets may be accepted and buffered by the proxy switch while signaling is being set up, so that the caller is not required to wait until the signaling connection is made to begin talking. The buffered voice packets may then be played back on the recipient's handset as soon as the signaling connection is made.

The media gateway ports are selected and used in passive data service mode in group call and PTT calls generally. In a latency situation, no port allocation is performed until a call is made, at which point port assignment is performed dynamically; the port assignment is valid for the length of the call and a 2 to 3 minute hold time, and the next call is a assigned a new set of ports.

In particular in the early streaming technique, the media gateway ports are pre-allocated and are monitored to aid call control in a group call. In the soccer club example, at any particular time one person is the caller and all of the others are recipients. The person who presses the appropriate handset button person has talk control; when talk control is released using the button, another member on the call can assume talk control by pressing the corresponding button on the member's handset. If no one presses the button within a period time, the call is dormant.

The transfer of control, which is described in copending U.S. application Ser. No. 09/845,934, consumes time that contributes to latency. Time is consumed as the system recognizes that talk control has been relinquished and as the system grants talk control to another member. Pre-allocation of ports allows the ports to be monitored so that call control can be assigned based on detection of activity on a particular port. For example, if initial voice packets are detected as being directed to a port corresponding to person A, it may be assumed that the voice packets represent a message that amounts to “Are you there?”, and talk control can be assigned to person A before person A presses a button. If packet activity is detected on more than one port, a random selection process may be executed to assign talk control.

Another latency reduction technique referenced herein as an “optimal transmission” technique reduces media latency at least in part by compressing the session initiation protocol (SIP) headers used in explicit signaling messages, compressing registration information, and using Short Messaging Service (SMS) to carry the registration information. Accordingly, the latency due to dormancy is reduced because it is not necessary for PSD sessions to be available for carrying SMS traffic, since SMS uses signaling channels that are not subject to R-P contexts.

In a particular example of compression, the MS strips unnecessary information from the SIP headers. Other methods of data compression or data reduction may be used instead or as well.

In particular, SIP may be used for PTT service, and the technique includes reducing the amount of information that SIP transfers. In addition, the technique may rely on SMS to carry the information as an SMS message, which reduces latency because SMS, which relies on signaling links, is not subject to dormancy; the information can be transmitted and received without requiring the handsets to execute a transition from dormant mode. In particular, to send the SIP signaling, SMS is used instead of using channels associated with the R-P context. The proxy switch receives and interprets the SMS message and acts accordingly for SIP signaling.

Another latency reduction technique referenced herein as a user interface optimization technique reduces latency by responding to user interface conditions. In at least some cases, a subscriber uses the user interface on the handset to locate a group before initiating a PTT call. The technique detects that the user's attention is directed to a group at the user interface level, and as a result an “intimation” message is sent to the potential recipients' handsets to initiate transitions from dormant to active states. In at least some cases, SMS may be used to send the intimation message.

In a particular example, a user may have multiple group call groups listed on the user's handset user interface, e.g., a soccer club group and a card playing group. To choose a group, the user scrolls down through the list of groups. If it is determined that the user intends to select a particular group (e.g., because the user has caused the cursor to linger over the group's listing for a period of time), the intimation message is sent to the recipient handsets that belong to the group. Thus, the recipient handsets can begin preparing for the group call before the user completes initiation of the group call.

Another latency reduction technique referenced herein as an alert optimization technique allows a caller to “ping” or “alert” the intended recipient party by using the caller's user interface on the caller's handset to send an alert message to the intended recipient's handset. Thus, a caller may use the handset to help determine whether the intended recipient is available and willing to receive the PTT call. As a consequence of the alert message, which may be sent via SMS, the recipient's handset may also execute a transition from a dormant state to an active state.

In a particular example, a group may be selected from a user's telephone book and the user may be able to press a button to cause an alert message to be sent to the intended recipients' handsets to warn the intended recipients to be aware that a group call is being initiated. Each of the intended recipients' handsets may generate an audible signal, to prompt the intended recipients to pick up the handsets or otherwise prepare for the call.

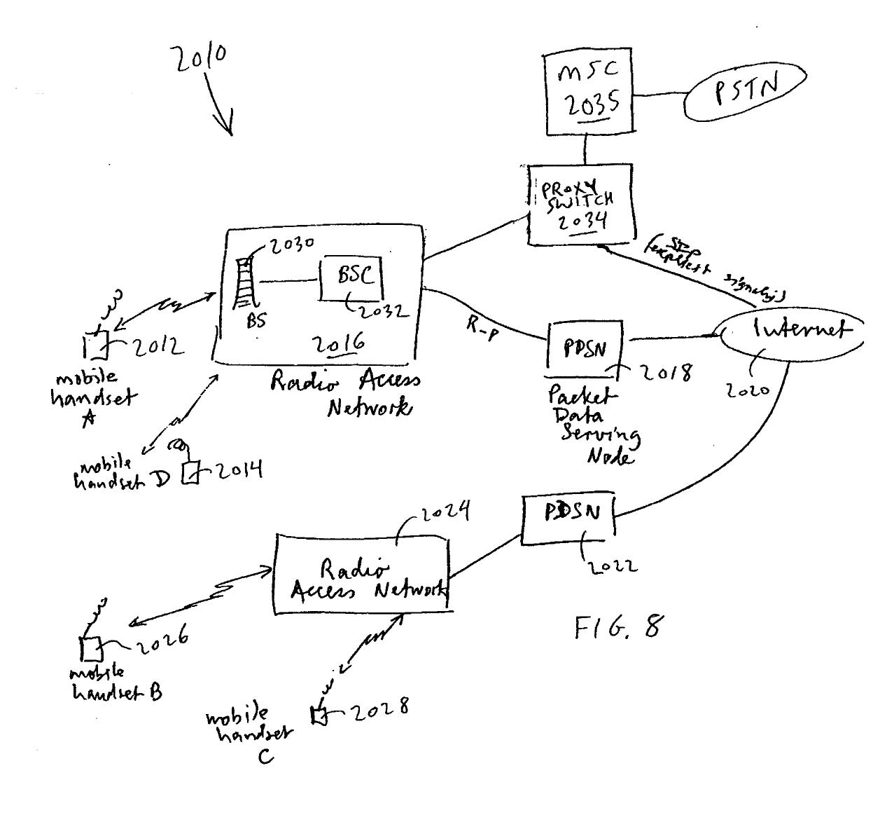

FIGS. 9-20 illustrate sample flow diagrams of latency situations and of corresponding procedures that may be used in one or more of the latency reduction techniques for expediting call establishment.

FIG. 9 illustrates a latency situation in a registration request (e.g., for a group call) in which a mobile handset A (handset 2012 in FIG. 8) is turned on and issues an “SIP register” registration initiation message to the proxy switch, the registration request is processed by the proxy switch, and the proxy switch responds with an “ACK” acknowledgement message.

With respect to the latency situation of FIG. 9, FIG. 10 illustrates a latency reduction technique in which the proxy switch reacts to the SIP register message by determining the members of the handset user's group call group and negotiating port parameters (as described in copending U.S. application Ser. No. 09/845,934) to be used for potential calls with other users' handsets (e.g., handsets 2014, 2026, 2028 in FIG. 9).

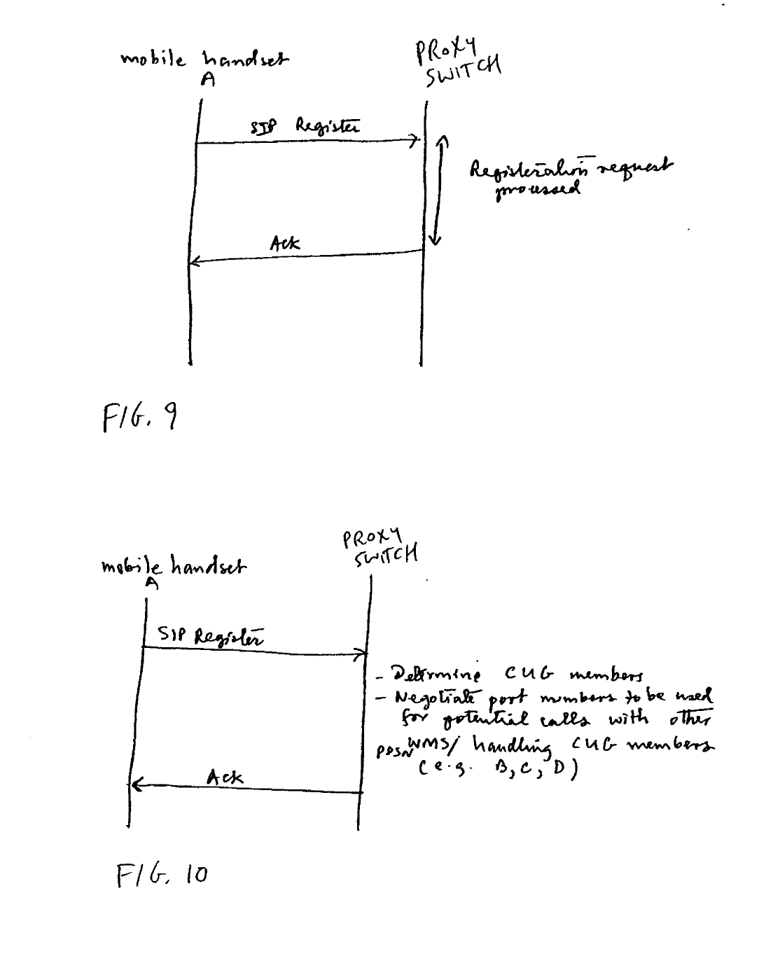

FIG. 11 illustrates a latency situation in which the user of handset A manipulates the handset's user interface to locate and select a group call group, handset A sends a first SIP invite message to the proxy switch, the proxy switch processes the first SIP invite message and sends a second SIP invite message to handset B, which processes the second SIP invite message. Handset B sends a first response message to the proxy switch which sends a second response message to handset A. Handset A sends a first RTP/UDP message to the proxy switch which sends a second RTP/UDP message to handset B. If handset A issues a talk control (“floor control”) relinquishment message to the proxy switch, the proxy switch sends a talk control available message to handset B. If handset B sends a talk control request to the proxy switch, the proxy switch processes the talk control request together with any other talk control requests that may have come in from other handsets, and as a result may send a talk control grant message to handset B. Handset B then sends a third RTP/UDP message to the proxy switch which sends a fourth RTP/UDP message to handset A. If one or both of handsets A and B are initially dormant, further latency is added due to the transition or transitions from dormant state to active state.

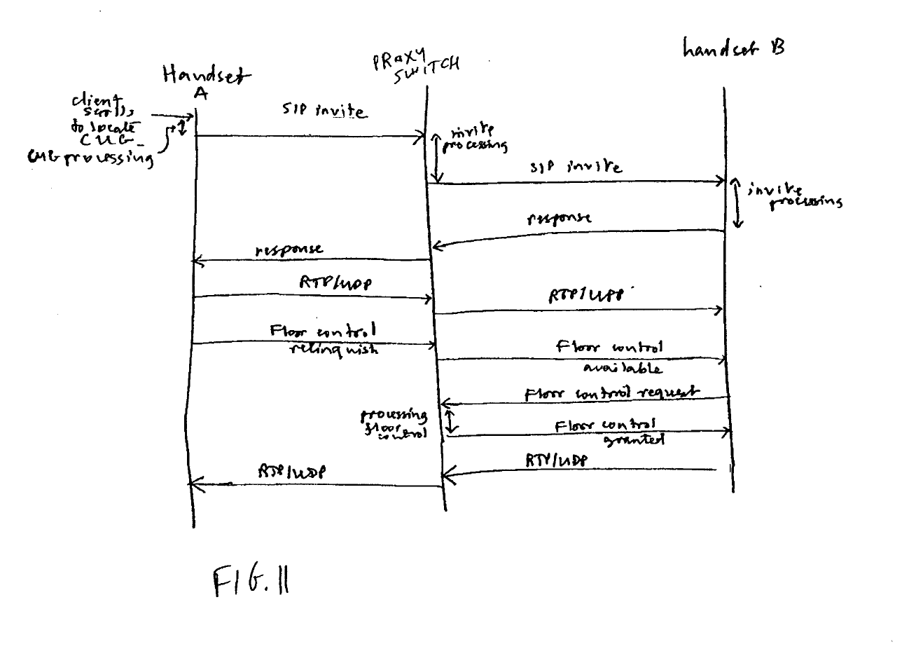

FIG. 12 illustrates a latency situation in which handset A sends an SIP invite message to the proxy switch, which processes the invite message, assigns talk control, and sends an acknowledgement message to handset A.

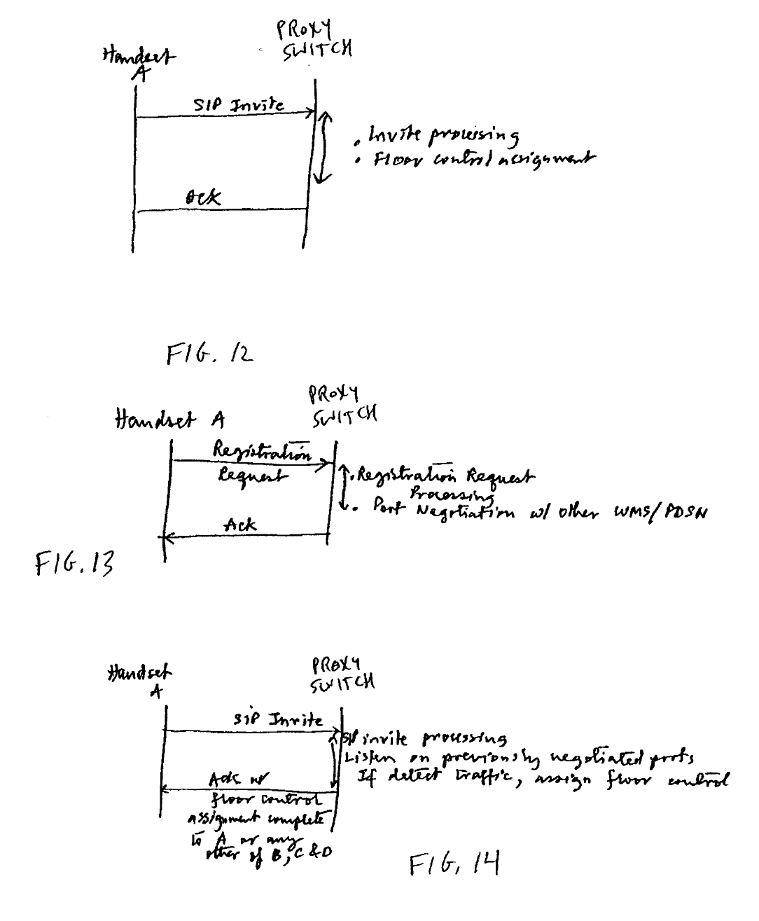

With respect to the latency situations of FIGS. 11-12, in a latency reduction technique responding to a registration request as illustrated in FIG. 13, handset A sends a registration request to the proxy switch, which processes the registration request and executes port negotiation with one or more other proxy switches and PDSNs, and sends an acknowledgement message to handset A.

Further with respect to the latency situations of FIGS. 11-12, FIG. 14 illustrates a latency reduction technique in which handset A sends an SIP invite message to the proxy switch, the proxy switch processes the SIP invite message and attempts to detect traffic on the ports that were previously negotiated as illustrated in FIG. 13. If such traffic is detected, talk control is assigned to the corresponding user, and an acknowledgement message is sent to handset A (or any of the handsets in the group) indicating that talk control has been assigned.

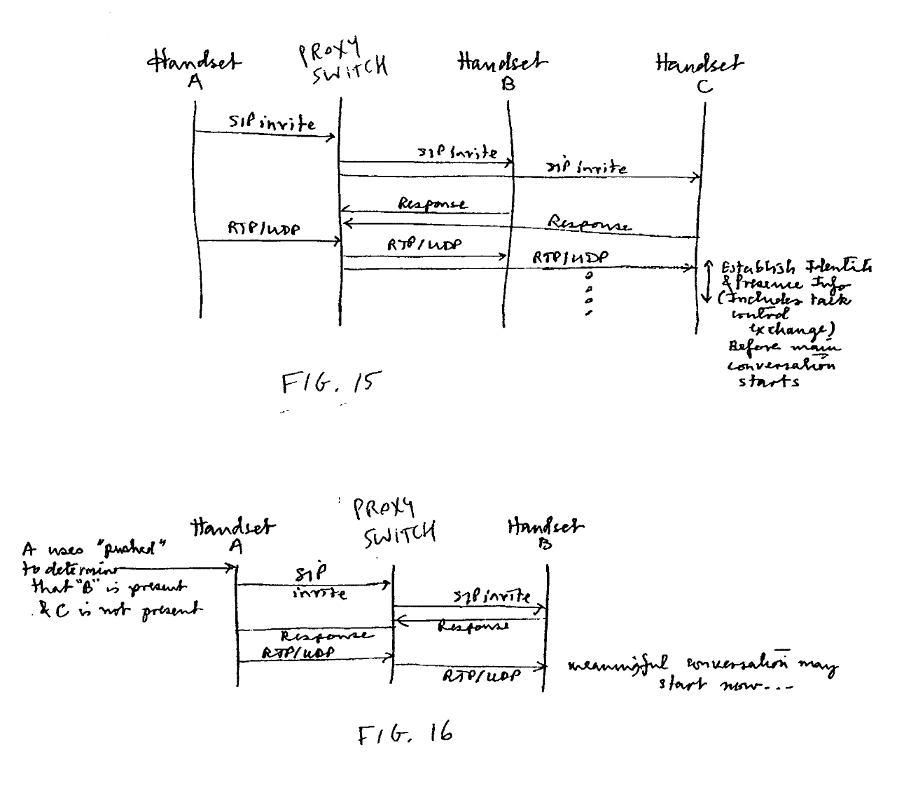

FIG. 15 illustrates a latency situation in a push to talk call (e.g., a group call) in which handset A sends a first SIP invite message to the proxy switch which sends a second SIP invite message to handset B and a third SIP invite message to handset C. After receiving first and second responses from handset A and handset B, the proxy switch receives a first RTP/UDP message from handset A and sends a second RTP/UDP message to handset B and a third RTP/UDP message to handset C. Identification and presence information is established and a talk control exchange is executed before the users' conversation can begin.

With respect to the latency situation of FIG. 15, FIG. 16 illustrates a latency reduction technique in which handset A has been informed that handset B is present and that handset C is not present. Handset A sends a first SIP invite message to the proxy switch which sends a second SIP invite message to handset B. Handset B sends a first response to the proxy switch which sends a second response to handset A. Handset A sends a first RTP/UDP message to the proxy switch which sends a second RTP/UDP message to handset B. The users' conversation can begin. Since handset C is indicated as not being present, it is unnecessary to send a third SIP message or a third RTP/UDP message to handset C, and it is unnecessary to receive a response from handset C, which saves time.

FIG. 17 illustrates a latency situation in which a sequence is executed as follows: handset A is in a dormant state, handset A executes a transition to active state, handset A has an R-P context activated, and handset A sends a registration message.

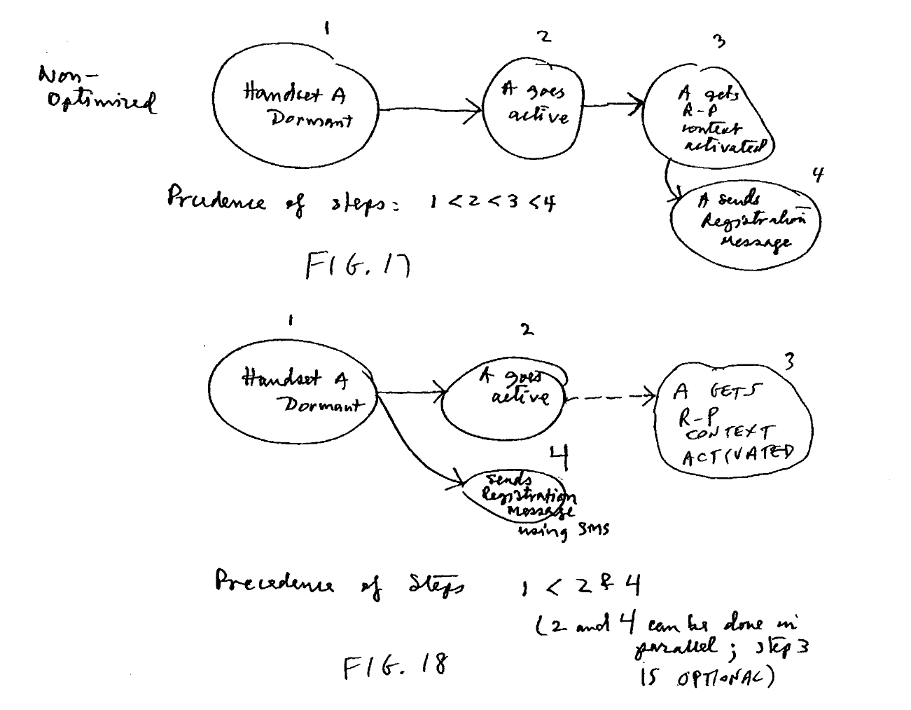

With respect to the latency situation of FIG. 17, FIG. 18 illustrates a latency reduction technique in which a sequence is executed as follows: handset A is in a dormant state, and handset A executes a transition to an active state in parallel with handset A sending a registration message using SMS. (Activating an R-P context is optional and may be done after handset A executes a transition to an active state.) Time is saved since handset A can send the registration message before completing a transition to active state.

FIG. 19 illustrates a latency situation in which a sequence is executed as follows. The user of handset A scrolls a listing in a user interface to find a group call group and selects the group call group in the user interface. Handset A causes invite messages to be sent to handsets corresponding to members of the group. The handsets execute transitions from dormant state to active state and respond to the invite messages.

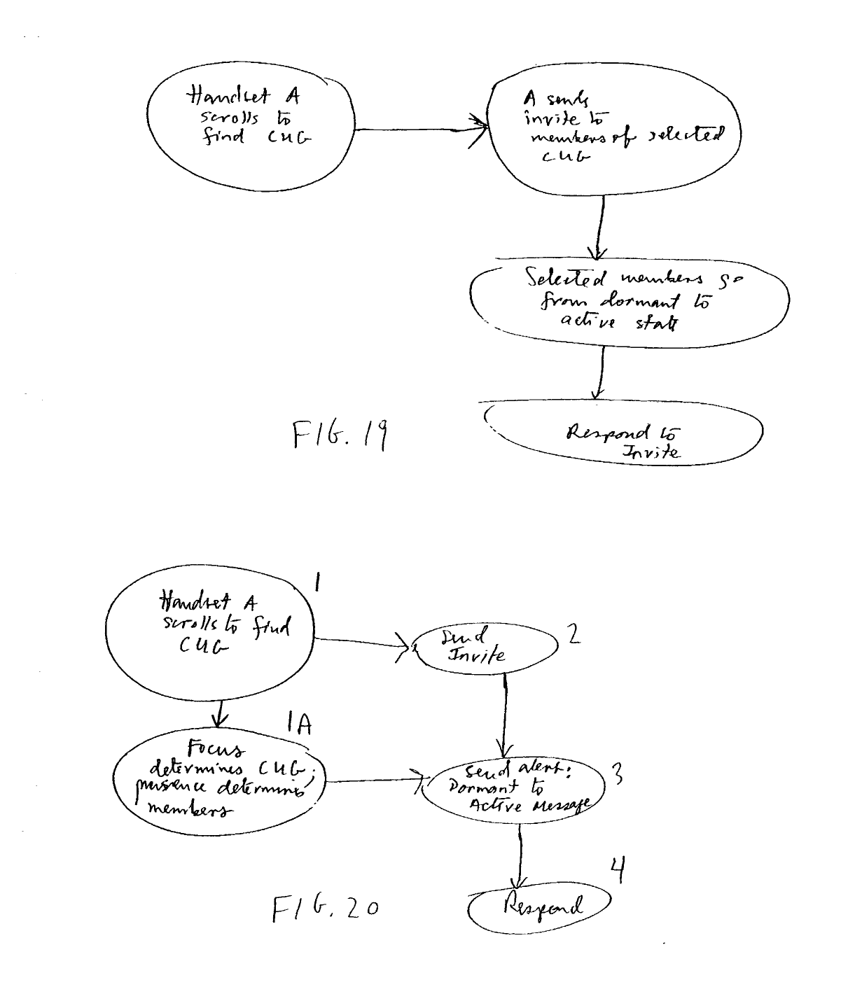

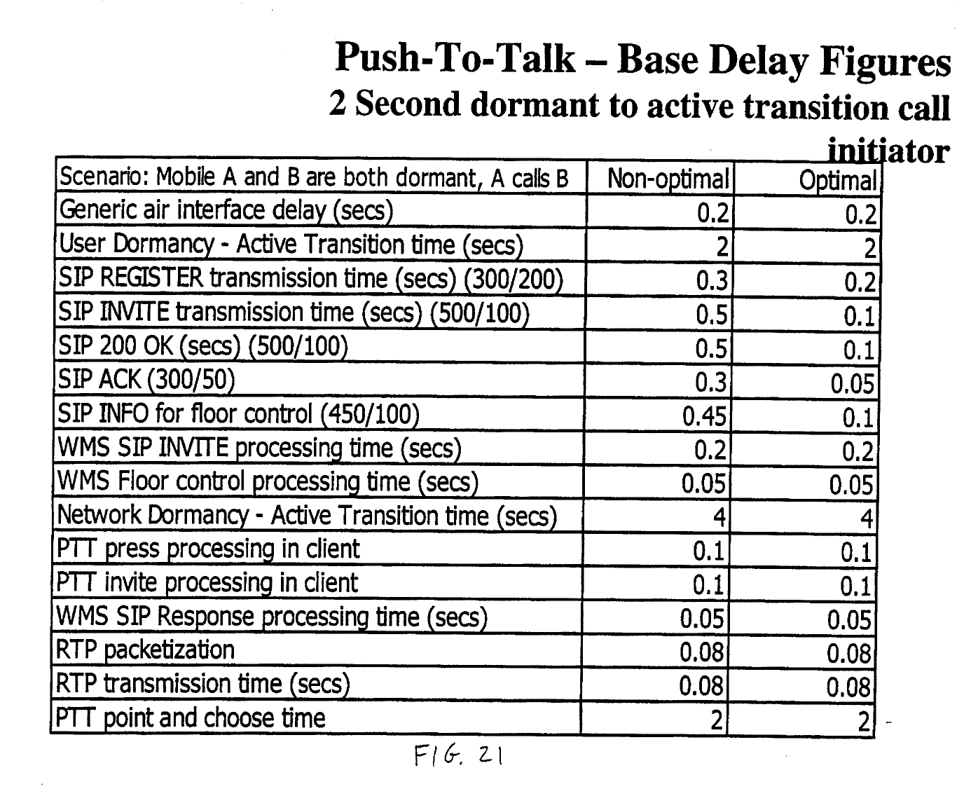

With respect to the latency situation of FIG. 19, FIG. 20 illustrates a latency reduction technique in which, as the user of handset A scrolls a list in a user interface to find a group call group, the user's focus on a listing is detected and presence status information is determined for the handsets corresponding to the users in the group identified by the listing. Handset A causes invite messages and alert messages (instigating transitions from dormant state to active state) to be sent to the handsets that are determined to be present, which handsets react by sending responses.

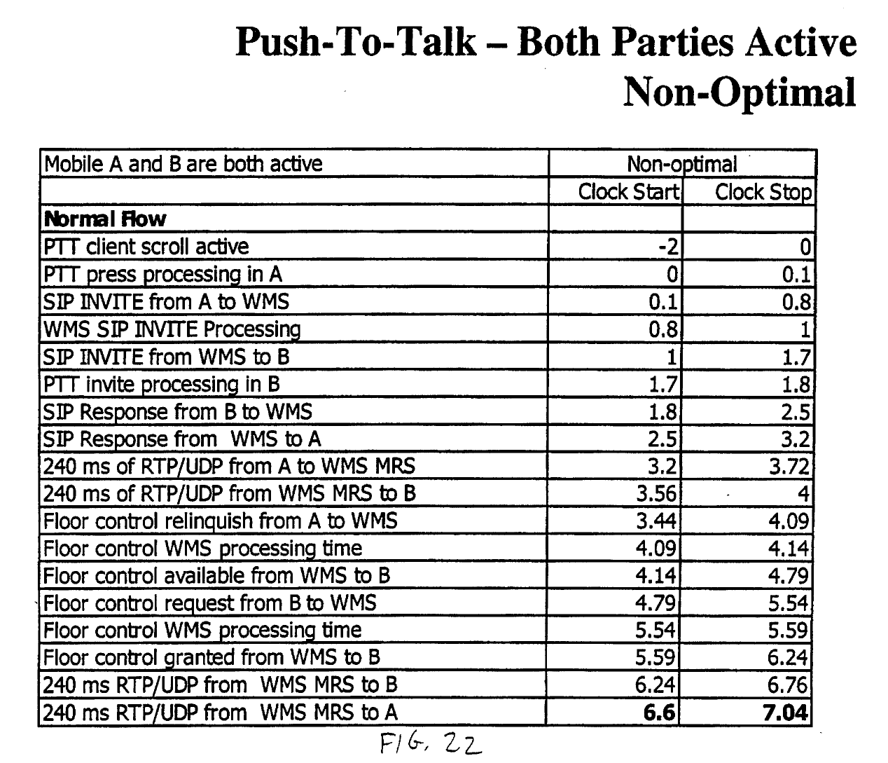

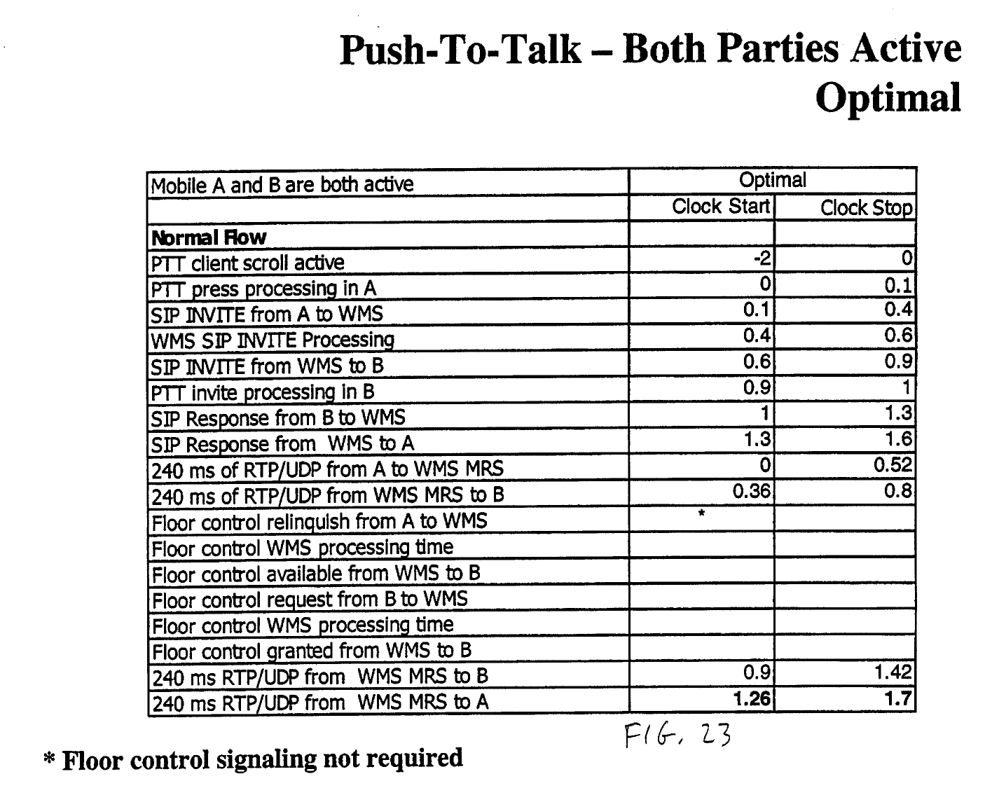

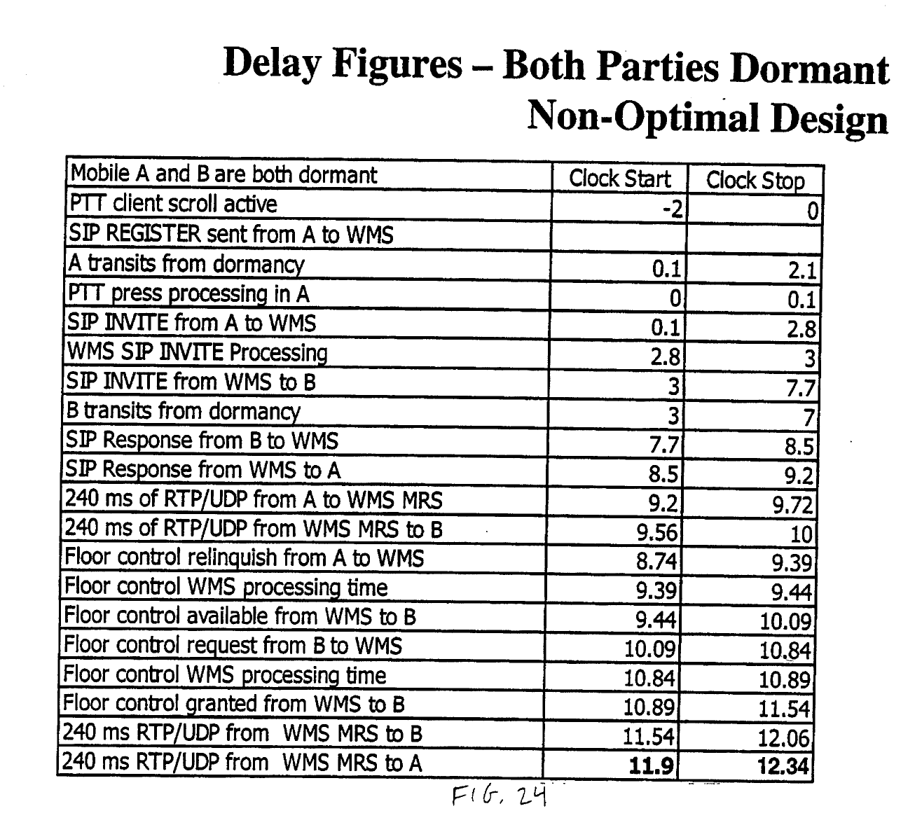

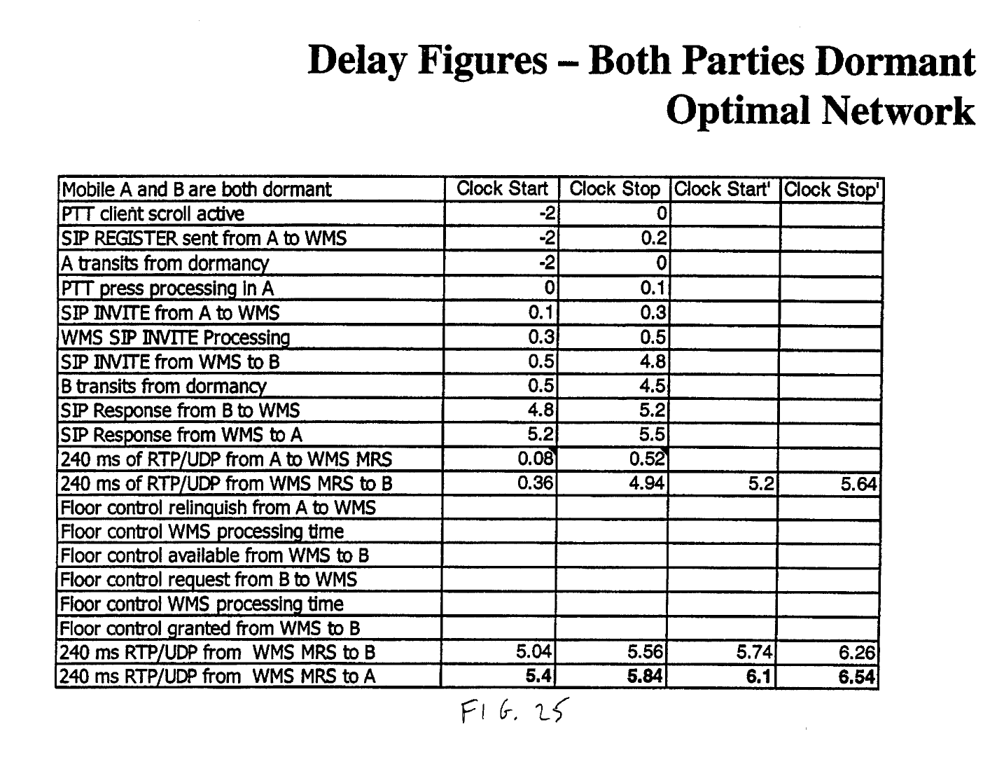

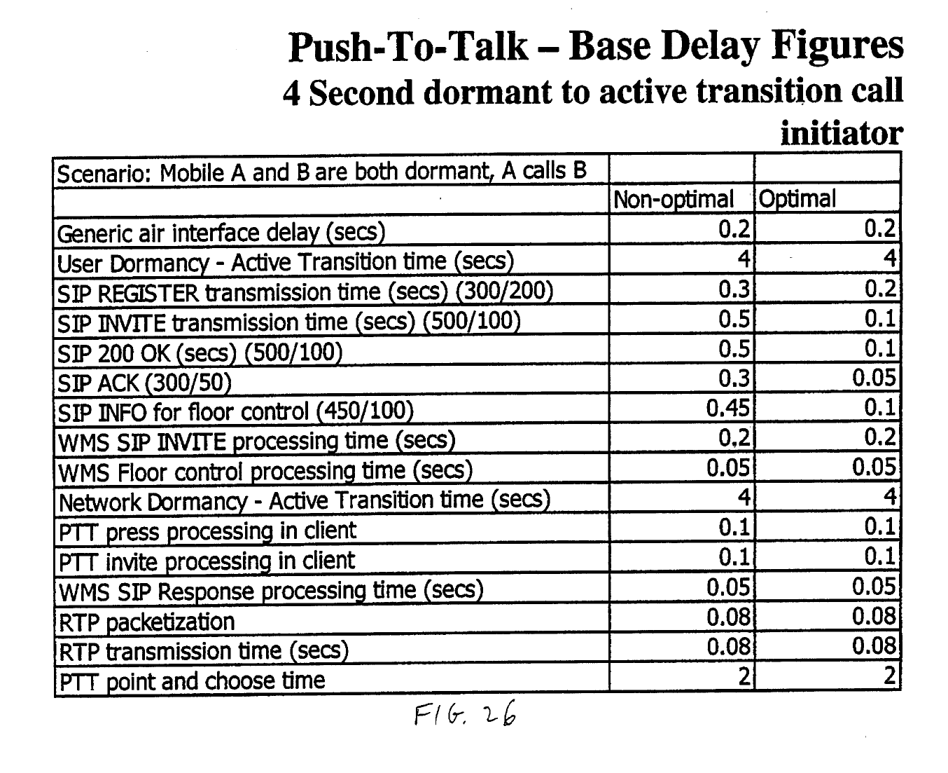

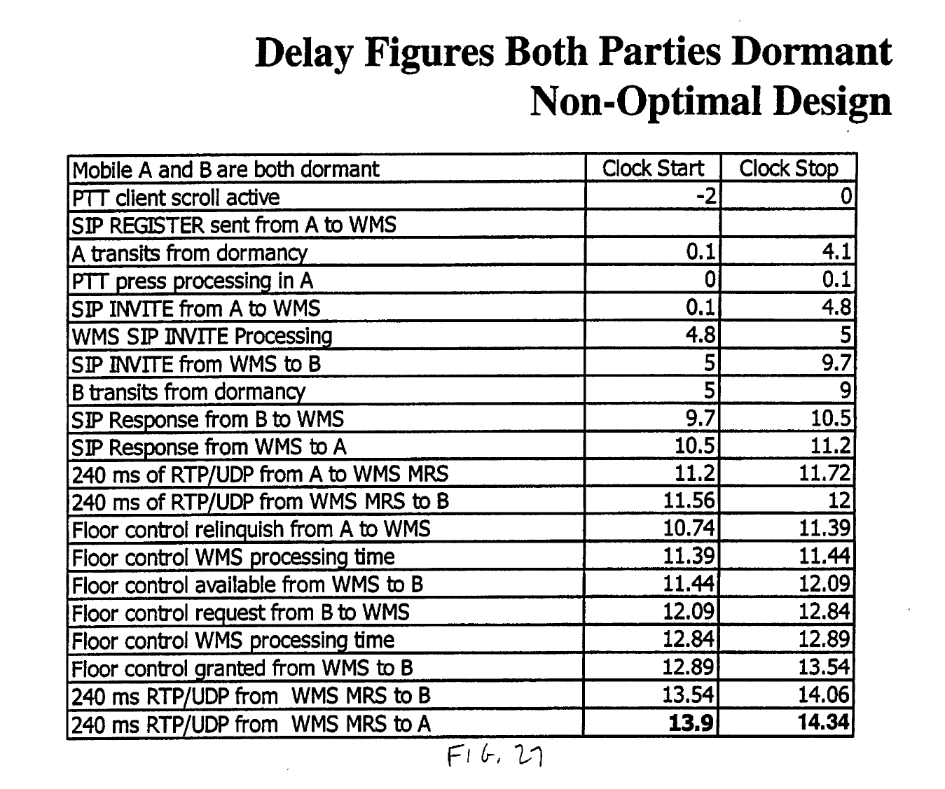

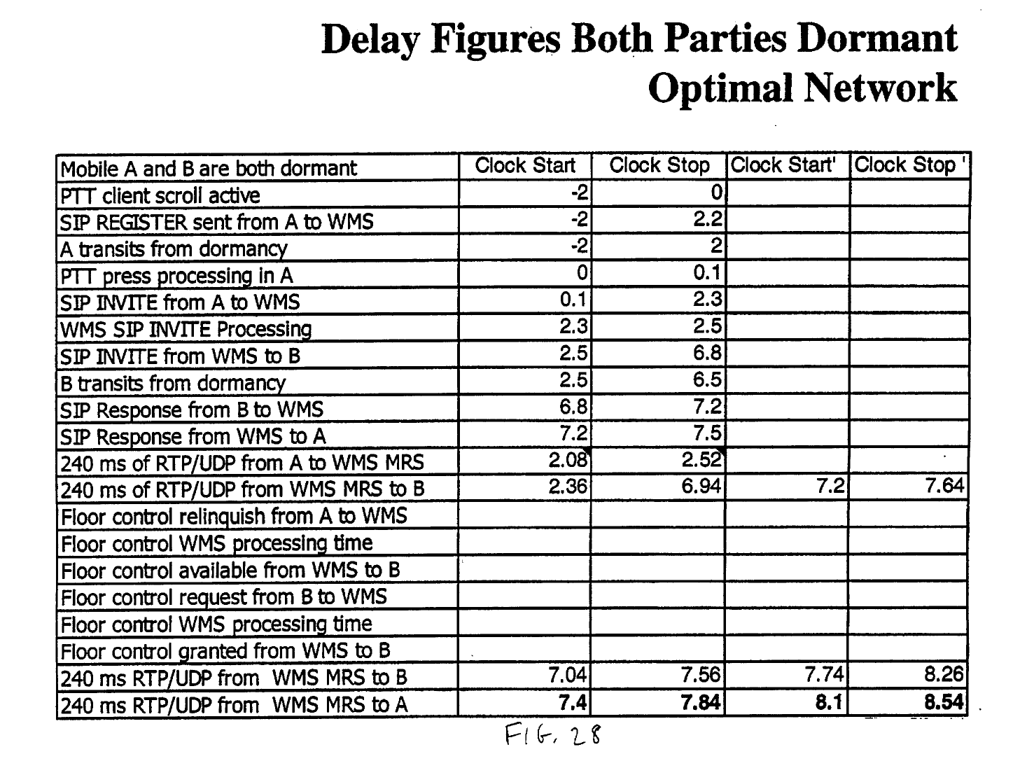

FIGS. 21-28 illustrate charts showing results of tests comparing the results of a system that lacks the latency reduction techniques (“a non-optimal system”) with a system that relies on one or more of the latency reduction techniques described above (“an optimal system”). FIG. 21 illustrates that the optimal system is found to have reduced latencies at least with respect to SIP register transmission time, SIP invite transmission time, SIP 200 OK, SIP ACK, and SIP INFO for floor control (talk control) and a 2 second dormant to active transition call initiator. FIGS. 22-23 illustrate that the optimal system is found to have reduced latencies at least with respect to call setup and floor control signaling when both parties' handsets are initially active. FIGS. 24-25 illustrate that the optimal system is found to have reduced latencies at least with respect to call setup and floor control signaling when both parties' handsets are dormant. FIG. 26 illustrates that the optimal system is found to have reduced latencies at least with respect to SIP register transmission time, SIP invite transmission time, SIP 200 OK, SIP ACK, and SIP INFO for floor control (talk control) and a 4 second dormant to active transition call initiator. FIGS. 27-28 illustrate that the optimal system is found to have reduced latencies at least with respect to call setup and floor control signaling when both parties' handsets are initially dormant.

Variations

The above embodiments all facilitate the realization of inventive expediting of call establishment in mobile communications. Subsets of the functionality, however, still provide advantages over the state of the art. For example, other call establishment parameters or other call setup information may be sent over SMS to avoid the latency resulting from the transition from dormant state to active state. In another example, one or more of the latency reduction techniques may be used in a full duplex call, a two-party call, a non-PTT call, a non-group call, or a non-voice call. In another example, the user interface may be configured so that whenever the user enters a group call group selection area (e.g., menu) of the user interface, wakeup messages are sent to the handsets of many or all of the other users that are linked to the user in group call groups, i.e., to the handsets of many or all of the users that are potential recipients of group calls originated via the user's group call group selection area. The wakeup messages may cause the handsets to execute transitions from dormant state to active state, to reduce latency. In another example, the availability of one or more of the latency reduction techniques may be dependent on the classes of services of more than one of the participants in the call, to provide incentives for participants to acquire higher classes of service.

In addition, to the extent the embodiments have been described in the context of particular wireless technologies such as TDMA or CDMA protocols, the embodiments may also be modified to work with wireless technologies including one or more of the following: TDMA, CDMA, GSM, IS-136, and other 2G and 3G protocols.

What is claimed is:

1. A method for use in expediting call establishment in mobile communications, comprising:
while a mobile station (MS) is in a dormant state, preparing the mobile station for a half duplex mobile communications telephone call; and
in response to a user's initiation of the half duplex mobile communications telephone call, establishing the half duplex mobile communications telephone call based on the preparation of the mobile station.

2. The method of claim 1, further comprising:
retrieving member information from a list of members of a group call group;
prior to establishment of the half duplex communications telephone call, providing the mobile station (MS) with presence information for at least one of the members.

3. The method of claim 1, further comprising:
prior to establishment of the half duplex communications telephone call, initiating port negotiation during a registration phase for the mobile station (MS).

4. The method of claim 1, further comprising:
compressing Session Initiation Protocol headers for the mobile station (MS).

5. The method of claim 1, further comprising:
compressing registration information for the mobile station (MS).

6. The method of claim 1, further comprising:
using Short Messaging Service to carry registration information for the mobile station (MS).

7. The method of claim 1, further comprising:
prior to establishment of the half duplex communications telephone call, based on the focus of a mobile user on a group indicated on a user interface, sending a message to another mobile station (MS) to cause the other MS to transition from a dormant to an active state.

8. The method of claim 1, further comprising:
prior to establishment of the half duplex communications telephone call, sending a status message to another mobile station (MS) to determine whether the other MS is ready to receive the half duplex communications telephone call and to cause the other MS to transition from a dormant to an active state.

9. A method for use in expediting call establishment in mobile communications, comprising:
retrieving member information from a list of members of a group call group;
prior to establishment of a group call for the group call group, providing a first mobile station (MS) with presence information for at least one of the members; and
based on the retrieved member information, establishing a group call between a second MS and the first MS, wherein the first MS is served by a first base station controller (BSC) and the second MS is served by a second BSC.

10. The method of claim 9, wherein the presence information indicates whether the at least one of the members has a handset that has responded to a paging request.

11. The method of claim 9, wherein the presence information indicates whether the at least one of the members has a handset that has generated a location update.

12. The method of claim 9, wherein the presence information indicates whether the at least one of the members has a handset that has executed a registration procedure.

13. The method of claim 9, further comprising
displaying, on a user interface display of the first MS, a visible indication based on the presence information.

14. A method for use in expediting call establishment in mobile communications, comprising:
retrieving member information from a list of members of a group call group;
prior to establishment of a group call for the group call group, initiating port negotiation during a registration phase for a first mobile station (MS); and
based on the retrieved member information, establishing a group call between a second MS and the first MS, wherein the first MS is served by a first base station controller (BSC) and the second MS is served by a second BSC.

15. The method of claim 14, further comprising
detecting traffic on a port used in the group call; and
assigning talk control to a member of the group call group based on the detection.

16. The method of claim 14, further comprising
using a proxy switch to buffer voice packets from the first MS prior to completion of a signaling connection to the second MS.

17. A method for use in expediting call establishment in mobile communications, comprising:
retrieving member information from a list of members of a group call group;
compressing Session Initiation Protocol headers for a first mobile station (MS); and
based on the retrieved member information, establishing a group call between a second MS and the first MS, wherein the first MS is served by a first base station controller (BSC) and the second MS is served by a second BSC.

18. The method of claim 17, further comprising
removing unnecessary information from Session Initiation Protocol headers.

19. A method for use in expediting call establishment in mobile communications, comprising:
retrieving member information from a list of members of a group call group;
compressing registration information for a first mobile station (MS); and
based on the retrieved member information, establishing a group call between a second MS and the first MS, wherein the first MS is served by a first base station controller (BSC) and the second MS is served by a second BSC.

20. A method for use in expediting call establishment in mobile communications, comprising:
retrieving member information from a list of members of a group call group;
using Short Messaging Service to carry registration information for a first mobile station (MS); and
based on the retrieved member information, establishing a group call between a second MS and the first MS, wherein the first MS is served by a first base station controller (BSC) and the second MS is served by a second BSC.

21. A method for use in expediting call establishment in mobile communications, comprising:
retrieving member information from a list of members of a group call group;
prior to establishment of a group call, based on the focus of a mobile user on a group indicated on a user interface, sending a message to a first mobile station (MS) to cause the first MS to transition from a dormant to an active state; and based on the retrieved member information, establishing a group call between a second MS and the first MS, wherein the first MS is served by a first base station controller (BSC) and the second MS is served by a second BSC.

22. The method of claim 21, further comprising
determining that the mobile user intends to select the group.

23. The method of claim 21, further comprising
detecting that the mobile user has caused a cursor on the first MS to linger over the group's listing.

24. A method for use in expediting call establishment in mobile communications, comprising:
retrieving member information from a list of members of a group call group;
prior to establishment of a group call, sending a status message to a first mobile station (MS) to determine whether the first MS is ready to receive the group call and to cause the first MS to transition from a dormant to an active state; and
based on the retrieved member information, establishing a group call between a second MS and the first MS, wherein the first MS is served by a first base station controller (BSC) and the second MS is served by a second BSC.

25. The method of claim 24, wherein the status message causes the first MS to generate an audible signal.

26. A system for use in expediting call establishment in mobile communications, comprising:
a mobile station (MS) being in a dormant state and being preparing for a half duplex mobile communications telephone call; and
a proxy switch responsive to a user's initiation of the half duplex mobile communications telephone call to establish the half duplex mobile communications telephone call based on the preparation of the mobile station.

27. A method for use in expediting call establishment in mobile communications, comprising:
while a mobile station (MS) is in a dormant state, preparing the mobile station for a half duplex mobile communications telephone call;
retrieving member information from a list of members of a group call group;
prior to establishment of the half duplex communications telephone call, providing the mobile station (MS) with presence information for at least one of the members;
prior to establishment of the half duplex communications telephone call, initiating port negotiation during a registration phase for the mobile station (MS);
compressing Session Initiation Protocol headers for the mobile station (MS);
compressing registration information for the mobile station (MS);
using Short Messaging Service to carry registration information for the mobile station (MS);
prior to establishment of the half duplex communications telephone call, based on the focus of a mobile user on a group indicated on a user interface, sending a message to another mobile station (MS) to cause the other MS to transition from a dormant to an active state;
prior to establishment, of the half duplex communications telephone call, sending a status message to another mobile station (MS) to determine whether the other MS is ready to receive the half duplex communications telephone call and to cause the other MS to transition from a dormant to an active state; and
in response to a user's initiation of the half duplex mobile communications telephone call, establishing the half duplex mobile communications telephone call based on the preparation of the mobile station.

28. A method for use in expediting call establishment in mobile communications, comprising:
determining a preselected class of service for a mobile station (MS);
based on the preselected class of service, applying a latency reduction technique to establishment of a half duplex communications telephone call for the MS.
